(19) United States
(12) Patent Application Publication
(10) Pub. No.: US 2011/0246223 A1
(43) Pub. Date: Oct. 6, 2011

(54) ACTIVE COMPLEX EVENT PROCESSING OR INFECTION CONTROL AND HYGIENE MONITORING

(75) Inventors: ELKE A. RUNDENSTEINER, ACTON, MA (US); DI WANG, WORCESTER, MA (US); RICHARD T. ELLISON, III, SHREWSBURY, MA (US)

(73) Assignee: UMASS MEDICAL SCHOOL, SHREWSBURY, MA (US)

(21) Appl. No.: 13/077,401

(22) Filed: Mar. 31, 2011

Related U.S. Application Data
(60) Provisional application No. 61/469,461, filed on Mar. 30, 2011.
(60) Provisional application No. 61/319,309, filed on Mar. 31, 2010.

(51) Int. Cl. G06Q 50/00; G06Q 99/00

(52) U.S. Cl. 705/2; 705/1.1

(57) ABSTRACT

An apparatus, system and method for processing a stream of events in accordance with a set of queries that apply complex event pattern matching, and for performance of actions in accordance with active rules associated with those queries. The execution of actions can take the form of system state changes that in turn can affect the outcome of other queries. Scheduling policies assure both correct and high-performance execution of concurrent event pattern queries and active rules. The stream of events can be associated with a variety of applications including monitoring of hygiene and infection control activities associated with health care.

### CROSS REFERENCE TO RELATED APPLICATIONS

This is a non-provisional patent application that claims priority and benefit to, co-pending U.S. provisional patent application Ser. No. 61/319,309 that was filed on Mar. 31, 2010 and entitled “Active Complex Event Processing Model and Infrastructure”, and claims priority and benefit to co-pending U.S. provisional patent application Ser. No. 61/469,461 that was filed on Mar. 30, 2011 and entitled “Active Complex Event Processing for Infection Control and Hygiene Monitoring”. All of the aforementioned patent applications are incorporated herein by reference in their entirety.

### FIELD OF THE INVENTION

This invention relates to an apparatus, system and method for processing a stream of complex events in accordance with a set of queries, and for performance of actions in accordance with active rules associated with those queries. The performance of actions affects the performance of queries. The stream of events can be produced by data sources from a variety of applications including for example, the provision of health care and hygiene monitoring and control associated with health care, algorithmic trading, fraud detection and other such applications.

### BACKGROUND OF THE INVENTION

The provision of health care is associated with numerous risks of infection for both patients and healthcare workers. One health care worker can become contaminated from being in contact with a patient, and can spread the contamination when coming in contact with other patients and/or other health care workers. Those other health care workers that become contaminated from patients that were contaminated are mobile and can further spread contamination. In addition, other unintentional healthcare worker activities can increase the risk of infection for patients. For example, an increase in the number of individuals entering or exiting an operating room during a procedure can increase the risk of infection for a patient.

### SUMMARY OF THE INVENTION

This invention provides for an apparatus, system and method for processing a stream of complex events in accordance with a set of queries and active rules associated with the queries. The performance of the actions affects the performance of the queries. The stream of events can be associated with a variety of applications, including for example, monitoring infection control practices or personnel movement associated with health care.

In one aspect, the invention performs queries upon a dynamic stream of events to identify actions to be performed to conduct internal state changes (that in turn affect query outcome) and to produce externally visible changes. The results of performing each of these queries which continuously read the internal state can prompt actions that change the values of these state in turn. The process of querying the streaming events while both querying and updating concurrently associated static data sets in a data store is subject to both correctness and the performance challenges that are addressed in the form of multiple algorithms described herein in accordance with the invention. Important components of the invention are the incorporation of timestamps for each action or rule that is implemented, and the use of stream transactions (s-transactions) that represent a sequence of system state changes that are triggered by a single input event.

The processing of stream transactions is performed in accordance with one of the multiple algorithms that are described herein.

### BRIEF DESCRIPTION OF THE DRAWINGS

The objects and features of the invention can be better understood with reference to the claims and drawings described below. The drawings are not necessarily to scale, and the emphasis is instead generally being placed upon illustrating the principles of the invention. Within the drawings, like reference numbers are used to indicate like parts throughout the various views. Differences between like parts may cause those like parts to be each indicated by different reference numbers. Unlike parts are indicated by different reference numbers.

FIG. 1 illustrates a top down view of a health care facility.

FIGS. 2A-2B illustrate a simplified representation of a host computer that monitors activity of health care workers within the health care facility via a communications network.

FIG. 3 illustrates a listing of a series of monitoring events associated with a plurality of health care workers.

FIG. 4 illustrates a simplified representation of an embodiment of an event processing apparatus and system of the invention.

FIGS. 5A-5D are simplified illustrations of s-transaction processing.

FIG. 6A is an illustration of a range of time that is employed by the third scheduling algorithm employed for processing of s-transactions.

FIG. 7 illustrates tracking the processing status of separate versions of health care worker associated status records in accordance with a third algorithm of the invention.

### DETAILED DESCRIPTION OF THE INVENTION

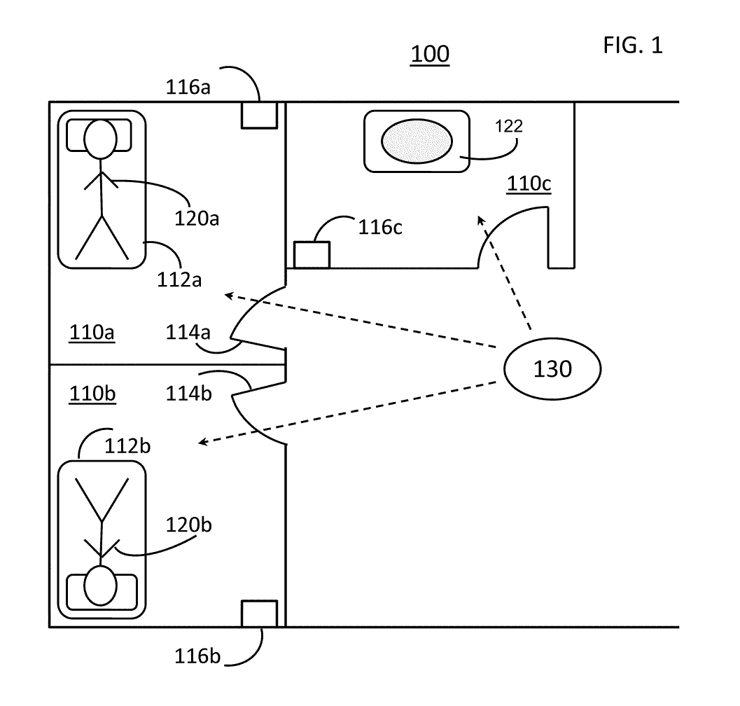

FIG. 1 illustrates a top down view (100) of a health care facility. As shown, the facility includes (2) patient care rooms 110a-110b that reside among other patient care rooms and that each include a bed (112a-112b) and a doorway through which a door (114a-114b) pivots, respectively. A health care patient (120a)is depicted as lying on the bed (112a) and a health care patient (120b) is depicted as lying on the bed (112b). Each doorway is also referred to herein as an entrance to each patient care room (110a-110b).

The facility also includes washing station (120) which is designed to facilitate washing and decontamination of the hands and other portions of the outer body of a health care worker 130. In this embodiment, the washing station is shown to reside inside a separate room (110c) and to include a sink (122). Sensors installed in the wash station identify and detect SANITIZE event of a particular healthcare worker. As shown, a health care worker (HCW) (130) is currently located outside of the patient care rooms (110a-110b) and outside of the washing room (110c) and is wearing a personally attached monitoring device (not shown). A wall mounted monitoring device (116a) is located within patient care room (110a) and is designed to detect a presence or an absence of a person wearing a personally attached monitoring device, such as the presence or absence of HCW (130). The wall mounted monitoring device also detects a transition between the presence and absence of a person wearing such a monitoring device, to identify and detect an ENTER or EXIT event of a particular person with respect to that particular MOM.

Upon walking into (entering) the patient care room (110a), the wall mounted monitoring device (116a) detects the sudden presence of the HCW within the patient care room (110a) and communicates an ENTER event to the event recording repository (not shown here). Also, when the HCW walks out of (exits) the patent care room (110a), the monitoring device (116a) detects the sudden absence of the HCW from within the patient care room (110b) and communicates an EXIT event to the event recording repository (not shown here).

Likewise, another monitoring device (116b), that is located in the patient care room (110b), also detects and communicates an ENTER or EXIT event associated with a monitored person, such as the HCW, to the event recording repository. Also, another monitoring device (116c), that is located in the wash facility room (110c), also detects and communicates an ENTER or EXIT event associated with a monitored person, such as the HCW, to the event recording repository.

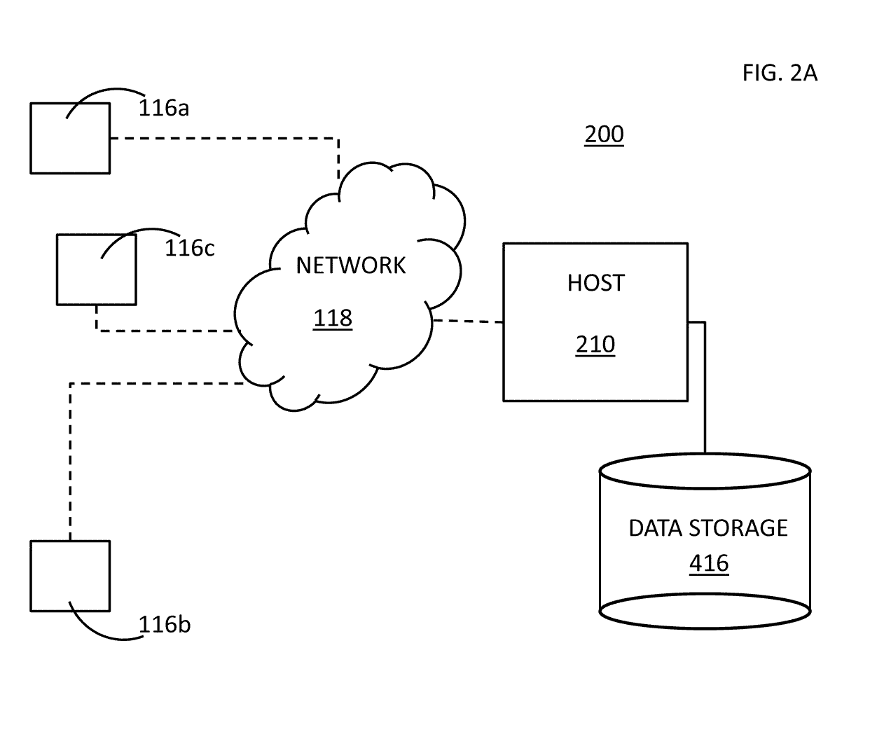

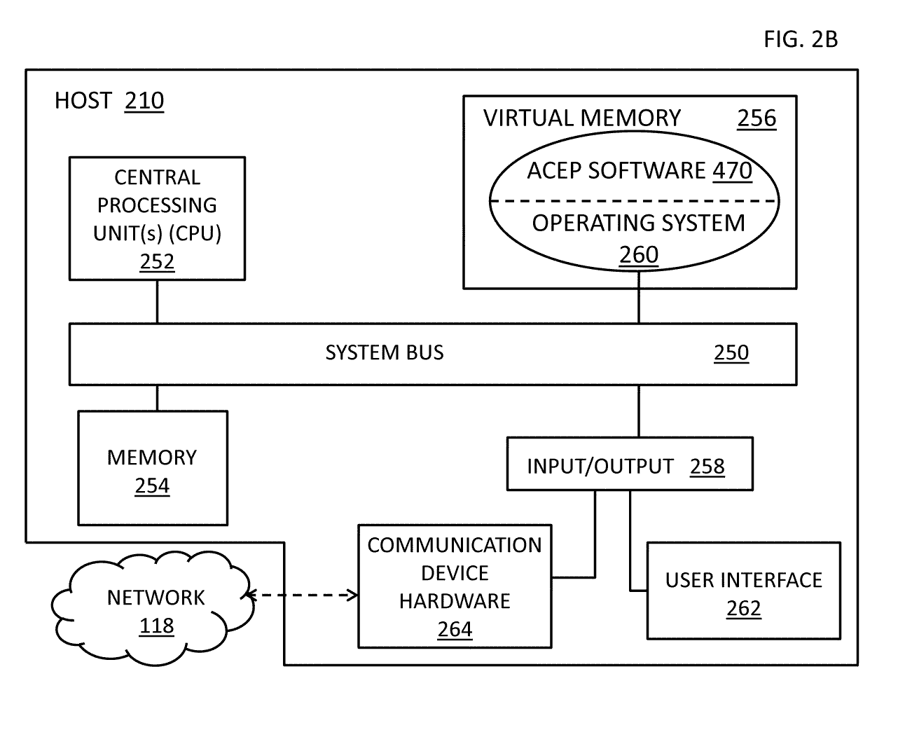

FIG. 2A illustrates a simplified representation (200) of a communications network that monitors activity of health care workers within the health care facility. As shown, monitoring devices (116a-116c) each communicate with a host computer (210) via one of the communications channels (212a-212c), respectively. Each of the communication channels may be implemented as a wire line or wireless (212a-212c) communications path. Each monitoring device (116a-116c) detects and communicates an event associated with a health care worker as a monitoring event. Each monitoring event is represented by a time of occurrence, an event type and by an identifier uniquely associated with a health care worker, along with possibly other attributes.

In some embodiments, these monitoring events simply represent detection and communication of a sudden presence or absence of a particular health care worker within a defined area at a particular time. Software, residing within the monitoring device (116a-116c) or residing within the host computer (210), interprets transitions between these events as an ENTER or EXIT event for example. In some embodiments, the host computer (210) may store each ENTER and EXIT event into non-volatile storage, such as a database (230). More importantly, other software on the host computer further processes these events in accordance with pre-defined long-running queries and rules using the active complex event processing techniques explained in later invention.

An example of an embodiment of a hand washing compliance monitoring system can be found within U.S. patent application publication serial number 20110063106 that was filed on Sep. 15, 2009 and entitled “Wireless Communication for Hygiene Dispenser Systems”. The aforementioned patent application publication is incorporated herein by reference in its entirety.

FIG. 2B is a simplified representation of a host computer implemented embodiment of the invention. In some embodiments, the ACEP apparatus is implemented as a computer software application executing on a network accessible host computer 210. The ACEP apparatus, implemented in this embodiment as ACEP computer software 470 is configured to inter-operate with an operating system 260, such as a Microsoft Version 7 operating system, via the Windows 7 operating system application programming interface. The computer software application 470 directs operations of a processor, such as for example, a central processing unit (CPU) 252 that is accessible via a system bus 250 residing within the architecture of the host computer 210. User interface 262 hardware is available for the ACEP software 470 to direct interaction with a user and/or administrator of the host computer.

Alternatively, the ACEP software can be programmed onto other operating systems and/or computing platforms, such as for example, programmed onto variants of UNIX, such as Linux or onto other Microsoft supplied operating systems, various IBM, real-time, or other Microsoft supplied operating systems. Preferably, the operating system 260 is designed to manage physical memory 254 as virtual memory 256 within which the ACEP software 470 and operating system software 260 reside.

The host computer 210 operates and interfaces with a computer network 118 via input/output 258 and communication device hardware 264. The network can be implemented as a local or wide area network, to enable the ACEP computer software application 470 to process events received from a variety of sources that reside at a variety of local and/or remote locations.

In some embodiments, the computer software application operates in association with web site that is accessible via a private or public computer network, such as the Internet. In some embodiments, the method, apparatus or system of the invention, spans across state or national boundaries and may interoperate with a network that spans across state or national boundaries. For example, the host computer 210 can be located in the Canada and the monitoring devices 116a-116c can be located at a health care facility within the United States. The ACEP computer software application can be stored onto portable media, such as for example, a compact disc or a universal serial bus compatible memory device.

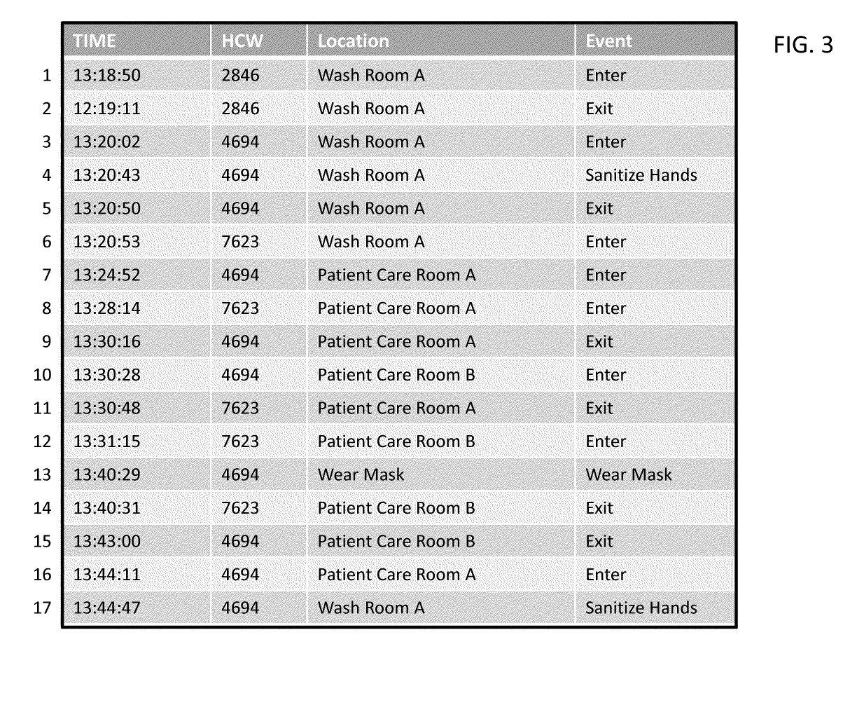

FIG. 3 illustrates a listing (300) of a series of monitoring events associated with a plurality of health care workers. As shown, the listing (300) includes (14) rows with (3) columns each of information for monitoring events associated with (3) health care workers. Each row of the listing (300) includes information representing a listed event. This information includes a time stamp, a health care worker identifier and a textual description of the event itself Each health care worker is represented by an identifier number that is unique to that health care worker. Each time stamp associated with each listed event is located in a left hand most column (312), each health care worker identifier is located in a center column (314) and each textual description of an event is located in a right hand most column (316). As shown, monitoring events associated with (3) health care workers are listed.

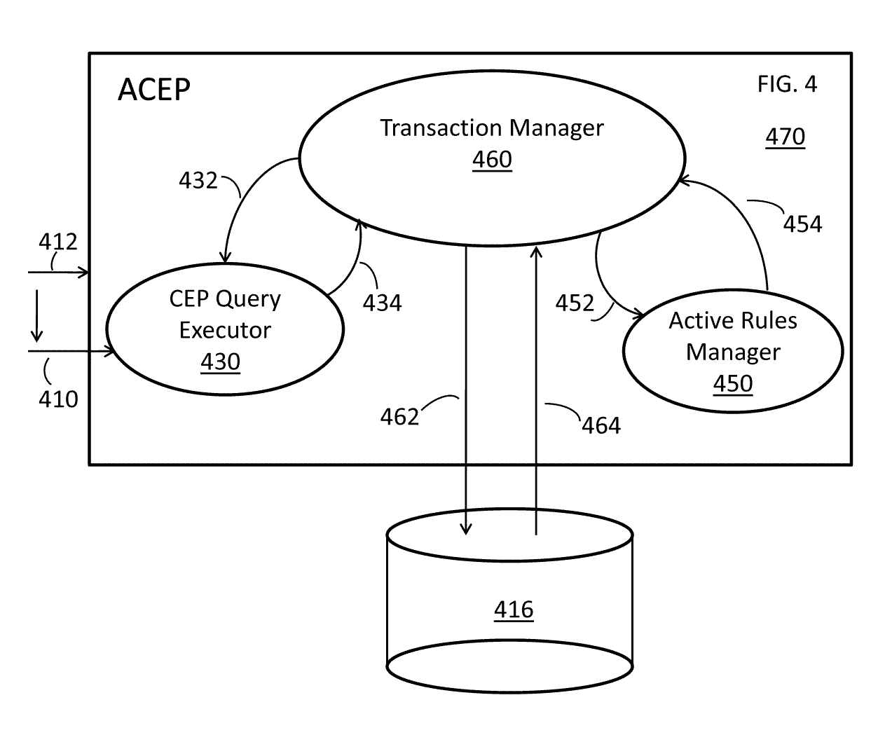

FIG. 4 illustrates a simplified representation of an embodiment of an event processing apparatus and system of the invention. As shown, an event stream (412) is communicated to the system (400) via a communication channel (410). In this embodiment, the communication channel (410) is implemented as a network communication path between the monitoring system (200) and the event processing system (400). Alternatively, the communications channel (410) is implemented as a non-wireless communications path, such as for example, a wireline or optical communication path.

In this embodiment, the event stream is digitally encoded and submitted to the active complex event processing software, as will be further explained. Additionally and optionally, the event stream may be copied and stored into a buffer (not shown) via an event logger (not shown) which is implemented as a software program. The buffer is preferably implemented as non-volatile storage, can be alternatively be implemented as a type of volatile storage.

An embodiment of the active complex event processing (ACEP) system 470 is composed of a transaction manager 460, a complex event processing (CEP) executor 430 and an active rules manager 450. The transaction manager 460 also includes a lock manager (not shown) that is embedded within the transaction manager 460. The lock manager synchronizes access to the shared store 416, which in some embodiments, can be implemented as one or more databases. In this embodiment, the complex event processing (CEP) executor (430) is designed to process an incoming event stream (412) in accordance with a set of one or more executing queries.

The transaction manager 460 communicates information to the CEP executor 430 via a communication path 432. This information includes for example, such as commands from the transaction manager 460 to the CEP executor 430. The CEP executor 430 communicates information to the transaction manager 460 via a communication path 434. This information includes for example, such as the execution status of each complex event processing query (CEP) query procedure and/or the result (including return status and timestamp) of a prior executing and terminating query match procedure.

Execution of the CEP executor 430 is preferably conducted in a push-based manner, (instead of pull-based manner), meaning that the devices embedded in the physical world push the observed events to the CEP executor via a communication network and the CEP executor consume them upon their arrival. Pull-based would mean that the CEP executor can pull any information at any time from a static database, as and when needed. As consequence, the status of matching a particular event pattern is tracked on an event by event basis, as an event is not read or input more than once by the CEP executor 430 for it to determine a match with respect to one or more query more patterns currently being processed (searched for within the event stream) by the CEP executor 430. In other words, pattern matching is said to be data driven and not control-driven.

Upon detection of a query pattern match, the CEP 430 executor communicates an occurrence of this pattern match event to the transaction manager 460. If an action is required to be performed in response to the occurrence of a particular pattern match, the active rule manager 450 is notified via communication path 452 by the transaction manager 460. In response, the active rule manager 450 executes an action procedure (not shown) to perform the action required to be performed.

The active rule manager 450 manages execution of one or more action procedures that are spawned (execution initiated) in response to the occurrence of pattern matches, such as for example, various query pattern matching events within the event stream 412. Active rules that are performed by associated active rule procedures subscribe to a particular query match result (output) of certain complex event processing query procedures.

In response to an query pattern match event notification that is communicated to the active rule manager, the active rule manager (440) may initiate execution (spawn/invoke) corresponding one or more active rule procedure (s) to perform some required action, such as setting or and/or modifying a value of one or more state variables, causing externally visible actions to be performed and/or performing writing of information to the shared store (416). In this embodiment of the invention, the data store (416) includes information, such as hygiene status information, for each of a plurality of health care workers.

The CEP executor 430 communicates a notification of a result of a performed query procedure indicating a match of a specified query event pattern detected from the event stream (412). In some embodiments, the result is communicated via communications path (434) if and when a particular query identifies a query match within the event stream (412). The communication of the notification of the result identifies the query type and query instance, and the event instances that constitute the query matches in the event stream, and indicates parameters associated with the query match, such as for example, query type, a health care worker identifier and/or time stamp of a match, if applicable. Many query procedure instances, each of a particular query type, can be executed in sequence, or in an interleaving fashion or in parallel during operation of the event processing system. Parallel processing is facilitated by availability of multiple processors for which an underlying operating system can allocate and schedule.

Each query pattern match has an associated time stamp. The time stamp of a query match is equal to the time of occurrence of the last monitoring event within the event stream (412) that is included within a particular query pattern match. The time of the time stamp corresponds to the application time when the corresponding observed event had arisen in the real world.

As an example, a first query (Q1) searches for a health care worker (HCW) who leaves a first patient care room, does not sanitize his/her hands and then enters a second and different patient care room. Typically, there is a patient residing within each of the first and second patient care rooms at the time of the HCW entry into each of these rooms. In this circumstance, contamination originating from a patient in the first patient care room can be transferred to the HCW and then transferred from the HCW to a patient located in the second patient care room.

A representation of this type of query can be expressed within the following sequence query language (also referred to herein as script) as SEQ(EXIT, !SANITIZE, ENTER), where the “!” symbol indicates a “not” operator. Said another way, (SANITIZE) denotes an event where an HCW worker washes his/her hands and (!SANITIZE) is a non-event where a HCW does not sanitize his/her hands within some period of time. In this example, the period of time is bounded between the time a health care worker exits an existing patient care room (EXIT) and the time that the same health care worker enters another patient care room (ENTER). The EXIT and ENTER events mark the start and end respectively of the period of time within which the HCW does not sanitize. In other embodiments of sequence query language, the time period can be fixed explicitly or implicitly in terms of time units, such as for example, 3 minutes of time.

Also, queries may have associated timing constraints, also called time window constraint. Such a time window constraint requires that all event instances that form a potential match to the query must have arisen with a certain number of time units away of each other at the maximum. For instance, the query Q1 may require that all events that form a potential match must have arisen with 3 time units of each other. A time unit can be equal to 2 minutes of time, for example.

Also, queries may have associated predicate conditions. The sequence query Q1 above may have the condition that the events indicated in the query specification, as SEQ(EXIT, !SANITIZE, ENTER), all refer to event with the same health care worker identifier. This could be specified as Q1 being “(EXIT, !SANITIZE.HCW-identifier=ENTER) WITH CONDITIONS (EXIT.HCW-identifier=ENTER.HCW-identifier) and (!SANITIZE, ENTER=SANITIZE HCW-identifier). It may also have additional conditions, such as, WITH CONDITIONS (EXIT.room-identifier NOT=ENTER. room-identifier). These conditions further constrain which events on the input event stream correspond to a given query match at any time. We henceforth omit the above identity-based constraints, and assume they similarly hold for all subsequent queries mentioned. A query also can have associated pre-conditions and action. The pre-condition to executing the Q1 query requires that the hygiene status of the health care worker associated with monitoring events of a match be equal to (SAFE). An action is performed upon a successful completion of a match for the Q1 query that sets the hygiene status of the matched health care worker equal to (WARNING). Said another way, a successful Q1 query match causes an associated active rule (R1) to also be executed that then in turn sets the hygiene status of a health care worker equal to (WARNING) from (SAFE).

For example, executing the above described Q1 query upon the event stream of FIG. 3, yields the following results. With respect to HCW (2846) no Q1 query match is found. With respect to HCW (7623) a Q1 query match is found at time 13:31:15. With respect to health care worker (HCW) (4694) a Q1 query match is also found, as explained below. As indicated within the event stream (412), the HCW (4694) sanitizes his/her hands at time 13:20:43, which sets the HCW (4694)'s status to (SAFE) as a pre-condition of the Q1 query. At 13:30:16 the HCW (4694) exits Patient Care Room A. At 13:30:28 the HCW (4694) enters Patient Care Room B. Further, within the period of time starting at 13:30:16 and ending at 13:30:28, no SANITIZE event had occurred. As a result, the Q1 query match is time stamped to occur at the same time of the monitoring event that completes the Q1 query match, which equals time 13:30:28.

In response to a Q1 query match being found, the CEP executor (430) communicates a notification of a result of this Q1 match to the transaction manager (460). The result of this Q1 match specifies a Q1 query type and matched event sequence, an HCW identifier, a HCW status which is equal to the pre-condition (SAFE) of the Q1 query and the time (timestamp) of the Q1 match equal to 13:30:28.

Upon monitoring the Q1 query match results, the active rule manager 450 determines whether any of its active rules (rule procedures) has subscribed (register to be notified/activated in response to a query match)) in monitoring this particular CEP Q1 query, and thus now should be initiated (triggered) for execution. In other words, the active rule procedure registers an interest in the occurrence of a particular query match result. For example, the R1 type of rule procedure, that is subscribing to the Q1 query, would be waiting to execute in response to a successful match found by the Q1 procedure. This R1 rule procedure instance sets the hygiene status of the HCW, that is associated with HCW having an identifier equal to 4694, equal to “WARNING”. This procedure then suspends or terminates its execution.

As an example, another defined query type, a second query type (Q2) searches for a health care worker (HCW) who wears protective garb before entering a first patient care room. This type of sequence pattern query can be expressed as SEQ (MASK, ENTER) where MASK signifies that the HCW is donning protective garb to cover the hands and face of the HCW and then enters a patient care room. Said another way, MASK is an event where an HCW worker wears a protective cover over his/her hands, whether or not those hands are sanitized at the time of initiating wearing of the protective garb.

As a pre-condition to executing the Q2 query, the hygiene status of the health care worker is required to be equal to (WARNING). An occurrence of a successful match for Q2 causes an instance of an associated rule type (R2) procedure to be executed. This R2 rule procedure sets the HCW hygiene status of a particular health care worker having a particular HCW identifier, equal to (SAFE).

Notice the difference between the Q1 and Q2 queries and actions. The Q1 query requires an HCW status to equal (SAFE) and when matched executes the R1 rule procedure to set the HCW status equal to (WARNING). The Q2 query requires an HCW status to equal (WARNING) and when matched executes the R2 rule procedure to set the HCW status equal to (SAFE).

Each executing query, also referred to as an executing instance of a query or query instance, is an executing copy of a query procedure. Each executing rule, also referred to as an executing instance of a rule or rule instance, is an executing copy of a rule procedure. Query instances and rule instances are each analogous to an executing instance (copy) of a process or executing instance of a thread, where multiple copies of the same program (process or thread) can be executing at one time. The execution of a rule instance procedure is typically invoked in response to a returned match of a pattern query.

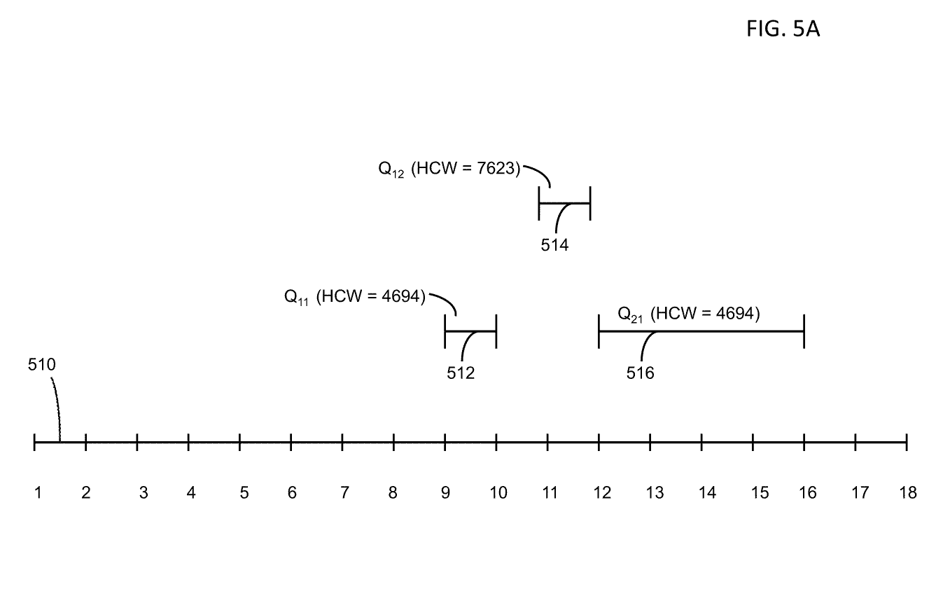

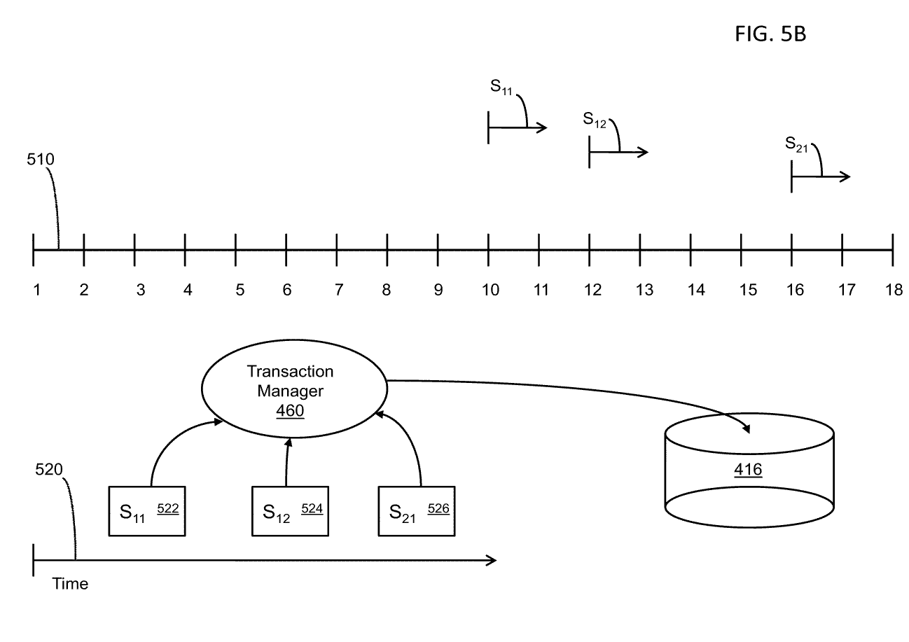

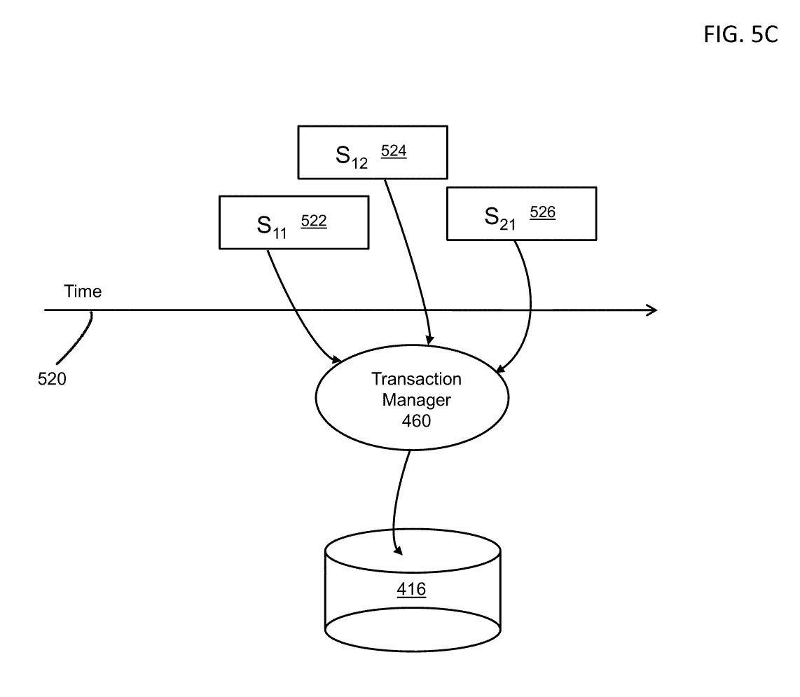

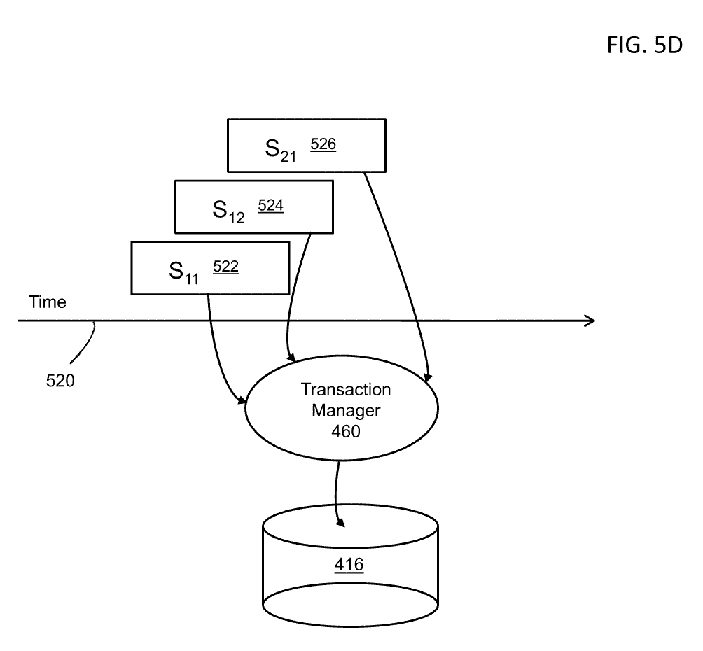

FIG. 5A is a simplified representation of query pattern matches with respect to event time 510. As shown, events occurring in real time, also referred to herein as event time 510, are represented to occur at event time indexes 1, 2, . . . 18 within event time 510. The event time indexes (1, 2, . . . 18) each represent the real time of occurrence of each event as listed in FIG. 3. For example, the event time at index 1 is equal to (13:18:50), the event time at index 2 is equal to (12:19:11) and the event time at index 3 is equal to (13:20:02), as listed in FIG. 3. Accordingly, these event time indexes are not equidistant from each other as measured in real time as listed in FIG. 3.

As shown, the event pattern searched for and matched by query 11 (Q11), indicating query type procedure 1 and query instance 1, with respect to health care worker (HCW=4694), starts at event time index 9 (13:20:50) and ends at event time index 10 (13:30:28). The event pattern searched for and matched by query 12 (Q12), indicating query procedure type 1 and query instance 2, with respect to health care worker (HCW=7623), starts at event time index 11 (13:20:53) and ends at event time index 12 (13:31:15). The event pattern searched for and matched by query 21 (Q21), indicating query procedure type 2 and query instance 1, with respect to health care worker (HCW=4694), starts at event time index 12 (13:31:15) and ends at event time index 16 (13:44:11).

An s-transaction is time stamped based on the application time of the event which triggers the s-transaction. In this circumstance, an s-transaction is triggered in response to detection/notification of a query pattern match associated with the s-transaction. The s-transaction (S11) is time stamped in association with event time index 10, which is equal to real (application) time (13:30:28), which is the time of the last event within the query pattern match. This corresponds to the first moment in time when the query match could have been identified. The s-transaction (S12) is time stamped to be equal to real (application) time (13:31:15). The s-transaction (S21) is time stamped in association with event time index 16, which is equal to real (application) time (13:44:11).

FIG. 5B is a simplified representation of earliest starting times for processing of s-transactions with respect to event time 510. The earliest time for which to initiate processing an s-transaction is when it is first triggered. As shown, the earliest time for which s-transaction (S11) can be initially processed is at event time index 10, which is equal to real (application) time (13:30:28). The earliest time for which s-transaction (S12) can be initially processed is at event time index 12, which is equal to real (application) time (13:31:15). The earliest time for which s-transaction (S12) can be initially processed is at event time index 12, which is equal to real (application) time (13:31:15). The earliest time for which s-transaction (S21) can be initially processed is at event time index 16, which is equal to real (application) time (13:44:11). The actual time for which processing is initiated for a particular s-transaction can vary and can occur sometime after the earliest time for the s-transaction can be initially processed.

With respect to another measure of time, referred to herein as processing time (also referred to herein as system time) 520, the elapsed processing time of each of the s-transactions (S11) (S12) and (S21) with respect to and relative to each other, is shown. As shown, as being processed in sequence by the transaction manager 460 and in accordance with a first scheduling algorithm.

In this embodiment, as referred to above, a first algorithm is employed that processes an event stream in the following manner. With this algorithm, stream transactions (s-transactions) and any spawned procedure instances encapsulated within these s-transactions are processed in accordance with the chronological order of the time stamp of the associated s-transaction. Any s-transaction, namely, the query procedure execution instance and all active rule procedure instances triggered by the query pattern match, if any, produced by the query procedure instance are processed in their entirety, before any new input event is read of the input queue. This assures that the s-transaction completes successfully, and accesses to the shared store 416 are synchronized to occur in the order as expected by the CEP query semantics. Said another away, stream transactions (procedure instances) are processed sequentially and non-concurrently.

FIG. 5C is a simplified representation of relative processing times for the s-transactions S11, S12 and S21 in accordance with a second scheduling algorithm. This second scheduling algorithm employs a two phase locking mechanism in the context of stream-transactions.

An s-transaction, upon its instantiation, first requests locks for variables in the shared store that it intends to potentially read or write during its execution. If a requesting rule procedure instance associated with an s-transaction is a read-only type of procedure, it acquires a read lock for a portion of the shared stored (416) to be accessed by the procedure instance. If the rule procedure instance is not a read-only type of procedure and could possibly perform a write operation on a portion of the shared store, it acquires a write lock for a portion of the shared store (416) to be accessed by the procedure instance.

A read or write lock request places the requesting procedure instance into a queue while waiting to obtain the lock and access to that portion of the shared store. A procedure instance associated with an s-transaction cannot access the shared store until after it has been granted the requested locks to portions of the shared store that it may perform a read or write operation upon. In fact, an s-transaction and its encapsulated procedure instances can proceed to access the shared store when all of its associated procedure instances have been granted their requested locks.

As shown, s-transaction S11 and s-transaction S12 can be processed concurrently by the transaction manager 460. The s-transaction S21 is processed sequentially relative to the s-transaction S11. This arrangement reflects that S11 and S21 are both associated with the same health care worker (HCW=4694) whereas S12 is associated with a different health care worker (HCW=7623). Hence, any record within the shared store 416 for the health care worker (HCW=4694) is first locked to process S11 and after completely processing S11, it is unlocked and then locked to process S12. No such locking conflict exists for S12.

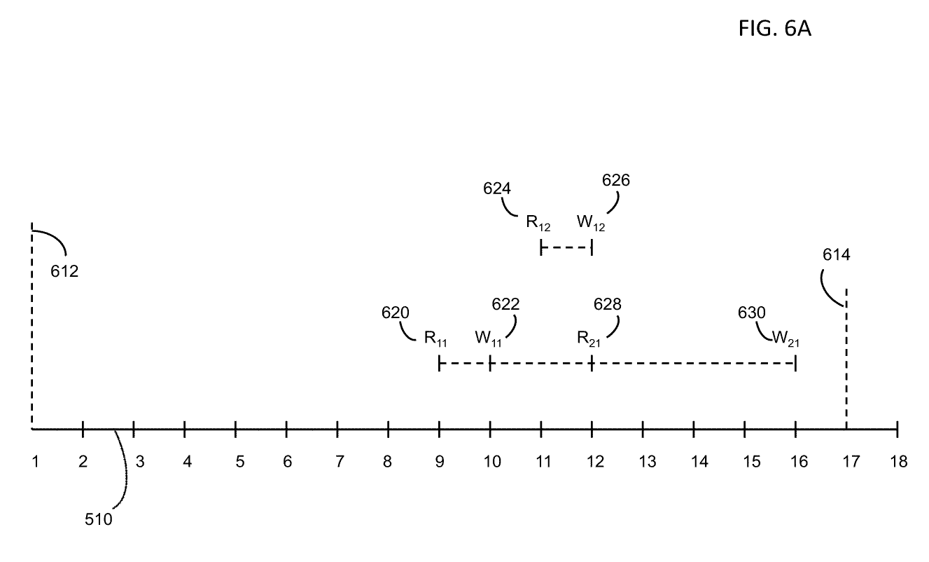

FIG. 5D is a simplified representation of relative processing activity for the s-transactions S11, S12 and S21 in accordance with a third scheduling algorithm. As shown, there will be circumstances when these (3) s-transactions are being processed with an increased level of partial concurrency compared to the first and second prior described scheduling algorithms. Any requirement that may exist for locking a portion of the shared store 416 is this circumstance, is not forcing strict sequential processing of these (3) s-transactions. This processing scenario is made possible by the employment of a third scheduling algorithm that is further described in association with FIG. 6A.

In this embodiment, a separate copy (also referred to herein as a version) of each portion of the shared store to be read or written by one or more s-transactions is created upon write of that portion of the store. For each such copy (version), each write operation associated with one or more s-transactions, that are being processed with respect to events occurring within a defined range within the event time line 510, is processed in time order and prior to processing any read operation within that range of time. Within the defined range of time, no read operation is processed until every write operation prior to the read operation is processed. This policy protects the read operation from reading a portion of the shared store 416 at an incorrect time, i.e., at the time when the value that is read is volatile and subsequently is changed. In this situation, we would say that the s-transaction read the portion of the shared store 416 too early. However, algorithm 3 avoids such a “too early read” from occurring.

This third algorithm enables the s-transactions, in this circumstance, S11 and S21, to be processed with at least partial concurrency despite that each s-transaction requires access to the same record (state variable) within the shared store at about the same time. The term partial concurrency is intended to mean that neither the S11 nor S21 s-transactions are processed during a period of time entirely while the other s-transaction is also being concurrently processed. As shown, processing of S11 is initiated prior to processing of S12 which is initiated prior to processing S21.

FIG. 6A is an illustration of a range of time that is employed by the third scheduling algorithm to bound its processing of s-transactions. This range of time is illustrated with respect to the event time line 510 as illustrated in FIG. 3. This range of time is shifted forward (later) in time as events are processed over time. The upper (later) end 614 of this range of time represents the latest event that has been processed by the scheduling algorithm. When an event has been processed, any associated operations to process the event, such as any read and write operations to the shared store have been completed for that event. This is only permitted if all write operations have been completed for any other event occurring and processed earlier in time with respect to the event time line 510. However, s-transactions with read only operations may in fact be able to read older versions of the shared store—as long as the low-water-mark of the third algorithm indicates that it is safe to do so. The upper (later) end of this range 614 is also referred to herein as a “low water mark”.

As shown, the s-transaction includes a read operation (R11) 620 that is performed in association with time index 9 and a write operation (W11) 622 that is performed. in association with time index 10. The S11 s-transaction is time stamped with a value equal to time index 10. The S12 s-transaction includes a read transaction (R12) 624 that is performed in association with time index 11 and a write transaction (W12) 626 that is performed in association with time index 12. The S12 s-transaction is time stamped with a value equal to time index 12. The S21 s-transaction includes a read transaction (R21) 628 that is performed in association with time index 12 and a write transaction (W21) 630 that is performed in association with time index 16. The S21 s-transaction is time stamped with a value equal to time index 16.

In accordance with the third algorithm, each read and write operation upon the shared store 416 is time stamped, namely, based on the time stamp associated to its encapsulating s-transaction. Also, multiple versions (historical records) of a portion of the shared store 416 that is the target of a read or write operation, are created and time stamped upon each write of that portion of the shared store. There is an assignment strategy for time stamps for locks upon these multiple versions of portions of the shared store. A special control parameter, referred to a “low-water-mark” is employed to maintain a synchronization order for locking and time stamping.

The execution of write operations is in accordance with the time stamped order of each write operation. In other words, a write operation is not allowed to “jump the queue” of scheduled write operations. A write operation upon a portion of the shared store 416 is allowed to write a versioned portion of the shared store when all write operations earlier than that particular write operation have been completed upon the portion of the shared store 416, i.e., a write operation will always append a newest (latest) time-stamped version to the shared store. On the other hand, a read operation upon a portion of the shared store 416 is allowed to read old versioned portions of the shared store provided that all write operations earlier than the read operation have been completed upon the portion of the shared store 416.

In some embodiments of the invention, the “low-water-mark” is employed in the following manner. A read lock is not granted and its access to a portion of the shared store 416 is delayed unless and until its time stamp becomes less than or equal to the time stamp of the low water mark. When the time stamp of a read operation becomes earlier than or equal to that of the low water mark, it is granted access to the portion of the shared store that is to be read by the read operation.

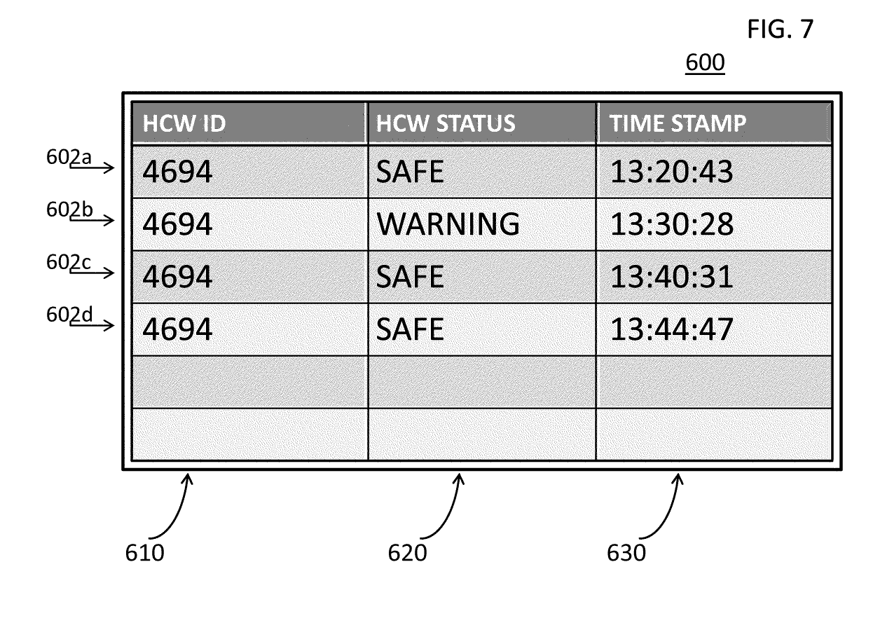

FIG. 7 illustrates tracking the processing status of separate versions of health care worker associated status records in accordance with a third algorithm of the invention. As shown, a two dimensional list (600) including (4) rows and (3) columns of information tracks status of portions of the shared data store (416) that are or have been requested for write access.

For this example, these portions of the data store (416) are HCW hygiene status table elements being write accessed, and possibly read accessed by one or more instances of procedures associated with s-transactions. Each row (602a-602d) of the list (600) represents a particular table element associated with a particular health care worker (HCW). A first column (610) of each row (602a-602d) indicates a HCW identifier, a second column (620) of each row (602a-602d) indicates a HCW hygiene status and a third column (630) of each row (602a-602d) indicates a time stamp associated with this version of the shared table.

As indicated, a first copy of the HCW hygiene status table element for a particular HCW associated with an identifier value equal to 4694 resides in a first row (602a). The first copy of this hygiene status table element indicates that a hygiene status is set to a (SAFE) status and has a time stamp equal to 13:20:43.

A second copy of this HCW hygiene status table element for the particular HCW associated with the identifier equal to 4694 resides in a second row (602b). The second copy of this hygiene status table element indicates that a hygiene status is set to a (WARNING) status and has a time stamp equal to 13:30:28.

A third copy of this HCW hygiene status table element for the particular HCW associated with the identifier equal to 4694 resides in a third row (602c). This third copy of this hygiene status table element indicates that a hygiene status is set to a (SAFE) status and has a time stamp equal to 13:40:31.

A fourth copy of this HCW hygiene status table element for the particular HCW associated with the identifier equal to 4694 resides in a fourth row (602d). This fourth copy of this hygiene status table element indicates a (SAFE) status and has a time stamp equal to 13:44:47.

This third algorithm allows for non-sequential processing of read-only procedure instances having differing time stamp values. An executing procedure instance(s-transaction) that is requesting for read access to this table element for health care worker (HCW) (4694) is directed (assigned) in accordance with this third algorithm to read a table element copy having a time stamp value that is nearest in time and equal to or earlier than the time stamp associated with the requesting read-only procedure instance.

For example, a read access request associated with a procedure instance having a time stamp value of 13:30:27 would be directed to read table element associated with row (602a), having a time stamp value equal to 13:20:43. Alternatively, a read access request having a time stamp value of 13:30:28 (one second later than the previous time stamp value) would be directed to read table element associated with row 602b, having a time stamp equal to 13:30:28.

In some embodiments, the ACEP apparatus is implemented as a computer software application that inter-operates with an operating system via the applications programming interface of the operating system. The computer software application directs operations of a processor, such as for example, a central processing unit (CPU) operating within a Microsoft Operating system based computer or a Linux operating system based computer. The computer preferably operates and interfaces with a computer network, such as a local or wide area network, to enable the computer software application to process events received from a variety of sources residing at a variety of locations.

In some embodiments, the computer software application operates in association with a web site that is accessible via the computer network. In some embodiments, the method, apparatus or system of the invention, spans across state or national boundaries and may interoperate with a network that spans across state or national boundaries. The computer software application can be stored onto portable media, such as for example, a compact disc or memory stick.

### OTHER APPLICATIONS

The subject matter of the invention regarding active complex event processing (ACEP) is a general-purpose methodology that can also be applied to many applications that either include or exclude hygiene monitoring. This is particularly true for applications that include timed event streams and that involve the tracking of certain status variables and/or values (states) of those variables over time.

The ACEP method can be applied to facilities designed for hospitality, such as for example, restaurants and hotels, golf clubs and other organizations with provide hospitality service to guests. In this context, we may for instance check the hygiene of staff servicing within such hospitality environments using similar procedures as outlined for the hospital environment.

The ACEP method can be applied to algorithmic trading. Algorithms developed for automated trading strategies often categorize financial products, say stocks, into various expected-operation groups like “to hold” or “to sell” in real-time. In the ACEP context, such groups and their corresponding category of “to hold” or “to sell” could be modeled by shared variables. Pattern queries monitor the fast-changing trends for a specific group of stocks. At the same time, the results of detected pattern may modify the group of a stock, e.g., a stock status modeled by a shared variable may be changed from “to hold” to “to buy”. Such real-time actions can be defined to occur in response to the occurrence of pattern queries. Execution of such actions could consequently change query results.

The ACEP method can be applied to real-time financial fraud detection. In this type of application, pattern queries are configured to selectively identify and process transactions issued by the sources in the “watch-lists”. The outcomes of a query may result in adding a source to the “alert-list” status or removing a source from the “watch-list”. Thus such updates of the list status may in turn affect the outcome of other monitoring queries. Given that the potential impact could amount to millions of dollars in savings, timely detection and appropriate action with respect to financial fraud is of utmost importance.

Furthermore, the inventive aspects of the above described invention can be applied to many other environments in addition to that of hygiene monitoring, algorithmic trading and financial fraud detection. Another alternative application of the ACEP method relates to tracking personnel in an operating room environment. When an excess number of individuals enter or exit an operating room during a given procedure, the risk of infection occurring increases. However, passively and in retrospect monitoring the number of personnel who have been involved in operations that have already been performed limits the potential interventions that a healthcare facility can perform to correct this situation. Consequently, the provision of real-time analysis of the number of individuals who are participating in ongoing operations can allow supervising staff to make interventions as necessary to prevent excess staff from becoming involved in procedures.

Within this type of ACEP application, healthcare worker activities in a suite of operating rooms would be monitored. Namely, door entry monitors would create an exact date-time entry or exit for each healthcare worker who entered or exited an individual operating room that was being monitored. Such events would then consumed by the ACEP technology for analysis and possibly action.

In addition, an optimal personnel limit would be established for each operative procedure as to the appropriate number of healthcare workers that should be allowed to participate in the procedure (e.g. the limit could be 12 individuals for cardiac surgery involving placement of a prosthetic aortic valve; or 5 individuals for a hysterectomy). When a procedure was scheduled for a given operating room, the optimal personnel limit would be assigned to that given operating room for the duration of the procedure by updating a shared variable called allowed limit for this particular operating room with the permitted count of health care workers. As explained above, information as to the entry and exit of individual healthcare workers into the operating room would be continuously monitored and analyzed.

At the initiation of a procedure, a second status variable associated with the given operating room, called the current population-count shared variable, would be assigned a value of 0. As each healthcare worker enters or exits an operating room and thus the corresponding motion event is consumed by the ACEP engine, the corresponding CEP query monitoring for motion into or out of a particular operating room would result in a match, thus triggering the appropriate active rule. The corresponding active rule would then change the operating room population-count variable by increasing by 1 for each healthcare worker entry and decreasing it by 1 for each healthcare worker exit.

Following the adjustment of the operating state variable, called population-count, as could be inferred by the consumption of an enter or exist event, a second query would be performed to compare this operating room state variable with the assigned optimal involved personnel limit variable. Should the personnel limit be reached or surpassed, then a real-time alert would be generated for supervising staff. In this model, the alert could be triggered either in relation to the number of individuals within the monitored operating room at any given moment, or in relation to the cumulative number of individuals who entered the operating room during the course of the operative procedure.

In this model, multiple operating rooms would be incorporated into the system with multiple operations performed each day in an asynchronous fashion with the ACEP analyzing all simultaneously. In addition, the complexity of the analysis by the ACEP could be expanded by using door entry monitors that identified healthcare workers based on badges carried by the healthcare worker. This would then allow analysis of the role of each healthcare worker in the operating room traffic flow, both as an individual as well as a member of a group (e.g. surgical staff, anesthesiology staff, OR nursing staff, etc.)

In summary, the subject matter of the invention provides for an apparatus, system and method for processing a series of events. The apparatus and system provide an event receiver that inputs information transmitted as a stream of events over time, an event processor that is configured to receive and process the stream of events in relation to at least one entity and in accordance with a set of one or more active rules, each of said active rules having at least one associated query procedure instance that is configured for searching for a pattern within said stream of events over time, the pattern representing an occurrence of at least one higher level event. The event processor is configured to perform at least one action based upon said occurrence of said higher level event; and wherein said action determines whether to alter at least one state variable that is associated with said higher level event in accordance with at least one of said active rules.

The Invention also provides for a method for processing a series of events. The method includes the steps of receiving a stream of events over time, and processing the stream of events in relation to at least one entity and in accordance with a set of one or more active rules, each of the active rules having at least one associated query procedure instance that is configured for searching for a pattern within said stream of events over time, the pattern representing an occurrence of at least one higher level event, and performing at least one action based upon said occurrence of said higher level event; and wherein said action determines whether to alter at least one state variable that is associated with said higher level event in accordance with at least one of said active rules.

In some embodiments, the pattern of events include a location status event and an action status event. In some embodiments, the location status event represents that an entity being a particular person is located within boundaries of a pre-defined area at a particular time. In some embodiments, the entity represents a health care worker and wherein the action status event represents one of a set of actions including a hand washing, hand cleanliness measurement, glove retrieval, mask retrieval or gown retrieval. In some embodiments, an active rule is defined to assign a modified value to at least one hygiene status variable.

Optionally, the processor is configured to concurrently process a first execution instance of a first active rule procedure during a first time period and to process a second execution instance of a second active rule procedure during a second time period and wherein said first time period and second time period overlap in time, in accordance with a scheduling. Optionally, the processor is configured to execute s-transactions based on a scheduling policy and wherein at least one said execution ordering is altered in response to said scheduling policy and wherein said processor is configured for sequential processing of said second execution instance of said second active rule prior to processing of said first execution instance of said first active rule.

In some embodiments, the processor is directed in accordance with digital logic that is predefined and stored into non-volatile memory prior to operation of said processor. The digital logic can process a sequence query language that configures operation of said processor prior to processing said monitoring said events. The rule definition language configures operations of said processor prior to processing said active rules. The execution of at least one of the active rules with respect to an entity can be dependent upon a hygiene status of said entity.

In some embodiments, the processor is configured for concurrent execution of processor is configured to match a first pattern of events with respect to a first health care worker in accordance with a first active rule, and to concurrently match a second pattern of events with respect to a second person in accordance with a second active rule. Optionally, the processor is programmed to modify an execution status associated with a second execution instance in response to performing an action associated with a first execution instance. Optionally, the action includes the alteration of a state of a hygiene status shared variable representing the change of a hygiene status indicator. Optionally, the ACEP apparatus and system can be stored as a computer program that is stored onto computer readable media for transport, reading (loading) and execution on a compatible computer system.

What is claimed is:

1. An apparatus for processing a series of events, said apparatus comprising:
an event receiver that inputs information transmitted as a stream of events over time;
an event processor that is configured to receive and process said stream of events in relation to at least one entity and in accordance with a set of one or more active rules, each of said active rules having at least one associated query procedure instance that is configured for searching for a pattern within said stream of events over time, said pattern representing an occurrence of at least one higher level event; and wherein
said processor is configured to perform at least one action based upon said occurrence of said higher level event; and wherein said action determines whether to alter at least one state variable that is associated with said higher level event in accordance with at least one of said active rules.

2. The apparatus of claim 1 wherein said pattern of events include a location status event and an action status event.

3. The apparatus of claim 2 wherein said location status event represents that an entity being a particular person is located within boundaries of a pre-defined area at a particular time.

4. The apparatus of claim 2 wherein said entity represents a health care worker and wherein said action status event represents one of a set of actions including a hand washing, hand cleanliness measurement, glove retrieval, mask retrieval or gown retrieval.

5. The apparatus of claim 2 wherein an active rule is defined to assign a modified value to at least one hygiene status variable.

6. The apparatus of claim 1 wherein said processor is configured to concurrently process a first execution instance of a first active rule procedure during a first time period and to process a second execution instance of a second active rule procedure during a second time period and wherein said first time period and second time period overlap in time, in accordance with a scheduling.

7. The apparatus of claim 6 wherein said processor is configured to execute s-transactions based on a scheduling policy and wherein at least one said execution ordering is altered in response to said scheduling policy and wherein said processor is configured for sequential processing of said second execution instance of said second active rule prior to processing of said first execution instance of said first active rule.

8. The apparatus of claim 1 wherein said processor is directed in accordance with digital logic that is predefined and stored into non-volatile memory prior to operation of said processor.

9. The apparatus of claim 8 wherein said digital logic processes a sequence query language that configures operation of said processor prior to processing said monitoring said events.

10. The apparatus of claim 9 wherein said rule definition language configures operations of said processor prior to processing said active rules.

11. The apparatus of claim 1 wherein said execution of at least one of said active rules with respect to an entity is dependent upon a hygiene status of said entity.

12. The apparatus of claim 1 wherein said processor is configured for concurrent execution of multiple active rules and associated event sequence queries, as stream-transactions.

13. The apparatus of claim 1 wherein said processor is configured to match a first pattern of events with respect to a first health care worker in accordance with a first active rule, and to concurrently match a second pattern of events with respect to a second person in accordance with a second active rule.

14. The apparatus of claim 1 wherein said processor is programmed to modify an execution status associated with a second execution instance in response to performing an action associated with a first execution instance.

15. The apparatus of claim 1 wherein said action includes the alteration of a state of a hygiene status shared variable representing the change of a hygiene status indicator.

16. An active complex event processing computer program that is stored onto computer readable media, including:
an event receiver that inputs information transmitted as a stream of events over time;
an event processor that is configured to receive and process said stream of events in relation to at least one entity associated with said events in accordance with a set of one or more active rules, each of said active rules having at least one associated query procedure instance configured for searching for a pattern of events over time that represent an occurrence of at least one higher level event; and wherein
said processor is configured to determine performance of at least one action based upon said occurrence of said higher level event; and wherein said action determines whether to alter at least one state variable that is associated with said higher level event in accordance with at least one of said active rules.

17. A system for processing a series of events, including:
an event receiver that inputs information transmitted as a series of events over time;
an event processor that is configured to receive and process said stream of events in relation to at least one entity associated with said events and in accordance with a set of one or more active rules, each of said active rules having at least one associated query procedure instance that is configured for searching for a pattern within said series of events over time, said pattern representing an occurrence of at least one higher level event; and wherein
said processor is configured to perform at least one action based upon said occurrence of said higher level event; and wherein said action determines whether to alter at least one state variable that is associated with said higher level event in accordance with at least one of said active rules.

18. The system of claim 17 wherein said series of events over time are communicated to said event receiver via a communications network.

19. The apparatus of claim 2 wherein said entity represents a hospitality worker.
